(19) United States
(12) Patent Application Publication
(10) Pub. No.: US 2008/0168313 A1
(43) Pub. Date: Jul. 10, 2008

(54) MEMORY ERROR MONITOR

(76) Inventors: Michael A. Blocksome, Rochester, MN (US); Amanda Peters, Rochester, MN (US); Brian Smith, Rochester, MN (US); Brent A. Swartz, Chippewa Falls, WI (US)

Correspondence Address: CANTOR COLBURN LLP - IBM ROCHESTER DIVISION, 20 Church Street, 22nd Floor, Hartford, CT, 06103, US

(21) Appl. No.: 11/621,414

(22) Filed: Jan. 9, 2007

(51) Int. Cl. G06F 11/30

(52) U.S. Cl. 714/47; 714/57; 714/E11.179

(57) ABSTRACT

The present invention relates to a method for the active real-time monitoring of memory errors, the method comprising the steps of monitoring a plurality of compute nodes within a computing system for memory errors by at least one performance counter, monitoring the at least one performance counter, wherein the at least one performance counter is monitored by the use of an external monitoring application, the external monitoring application being configured to monitor the at least one performance counter by the use of a JTAG network, and acquiring sample values of memory error data that have accumulated at the at least one performance counter. The method further comprises the steps of determining if a predetermined amount of memory errors has occurred at the plurality of compute nodes, and notifying a computing system administrator in the event that the predetermined amount of memory errors has occurred.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates to the monitoring of memory components within a computing system, and particularly to the monitoring and acquisition of memory error data within a computing system wherein memory error information is obtained by the use of JTAG interfaces.

2. Description of Background

Blue Gene is a computer architecture project that was implemented for the creation of series of next-generation supercomputers by a cooperative project between IBM® and a consortium of private and governmental partners. The primary objective of the Blue Gene project was to construct a supercomputer based upon a massively parallel machine architecture, wherein the enhanced processing power of the Blue Gene supercomputer was to be applied to the study of biomolecular phenomena.

The first supercomputer created in the Blue Gene series was the Blue Gene/L computer. The Blue Gene/L supercomputer achieves teraflop scale computing operation through high density, low power consumption, and fast system interconnects. The high density of low power consuming characteristics of the Blue Gene/L supercomputer are achieved by the use of embedded processing units, the embedded processing units typically requiring less power to operate than standard server class processors. Each embedded processing chip uses system of a chip technology (SoC). SoC technology comprises integrating the components of a computing system upon a single chip (e.g., networking devices, processors, cache, and memory controller are all contained on a single chip). Within each Blue Gene/L supercomputer cabinet, the SoCs are physically packaged in up to 1024 compute nodes, the compute nodes comprising two (2) processors per node, thus providing for the capacity of up to 2048 processors per cabinet of a Blue Gene/L supercomputer.

The implementation of such a large amount of compute nodes in the Blue Gene/L supercomputer has inevitably led to the device having compute node system failures. In response to this difficulty the Blue Gene/L supercomputer has been constructed with the capability to electrically isolate defective hardware components, thus allowing for the unencumbered operation of the Blue Gene/L supercomputer. However, an identified problem with the Blue Gene/L computing system is that the reliability of the computer's memory, combined with the large number of compute nodes (up to 65,536 compute nodes), has caused reliability problems in regard to the compute nodes. Thus, within some Blue Gene/L computing systems the memory error rates on some compute nodes can be unacceptably high.

Within Blue Gene/L computing systems soft errors are typically recorded with a reliability, availability, and serviceability (RAS) event upon the completion of a job; typically these soft errors can affect the performance of an application within the computing system. Displaying the RAS events to a system operator as they occur can lead to a significant degradation in the performance characteristics of the computing system. Further, the flagging of the RAS events at the end of a job practically make it impossible to tell if a RAS event occurred during the execution of an application. Currently, there are no processes that dynamically monitor the memory error rate for the compute nodes of a BG/L system; therefore a need exists for a low system impact, real-time process to monitor memory errors that occur on the compute nodes of a Blue Gene supercomputing system.

### SUMMARY OF THE INVENTION

The shortcomings of the prior art are overcome and additional advantages are provided through the provision of a method for the active real-time monitoring of memory errors, the method comprising the steps of monitoring a plurality of compute nodes within a computing system for memory errors by at least one performance counter, monitoring the at least one performance counter, wherein the at least one performance counter is monitored by the use of an external monitoring application, the external monitoring application being configured to monitor the at least one performance counter by the use of a JTAG network, and acquiring sample values of memory error data that have accumulated at the at least one performance counter. The method further comprises the steps of determining if a predetermined amount of memory errors has occurred at the plurality of compute nodes, and notifying a computing system administrator in the event that the predetermined amount of memory errors has occurred.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a flow diagram detailing a method for the monitoring of memory error rates within a computing system in accordance with an embodiment of the present invention.

FIG. 2 illustrates aspects of a flow diagram component detailing an excessive memory error determination decision module that is implemented within embodiments of the present invention.

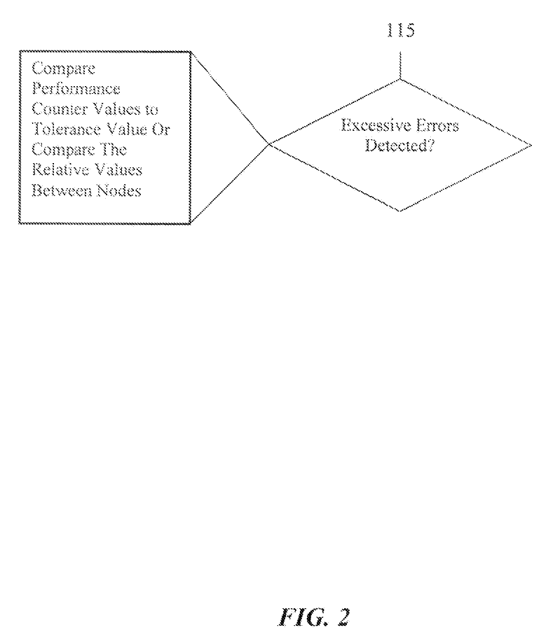

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to the illustrative only since numerous modifications and variations therein will be apparent to those of ordinary skill in the art.

The present invention can be used to improve the reliability of Blue Gene computing systems by monitoring the performance counters within the Blue Gene computing systems that monitor memory (e.g., CRC (Cyclic Redundancy Check) and SRAM (Static Random Access Memory)) errors on all of the compute nodes within a given system in order to detect compute nodes that have unacceptably high levels of memory errors. Performance counters are utilized within aspects of the present invention instead of hardware soft error detectors in order to provide less invasive real-time event monitoring and response operation functions.

Within aspects of the present invention performance counters that monitor memory errors within a compute node can be monitored on all of the compute nodes within a computing system in order to assist in determining the relative error dates that occur across the monitored compute nodes. An external process is implemented to monitor these counters using the JTAG network. JTAG, an acronym for Joint Test Action Group, is the name used for the IEEE 1149.1 standard entitled Standard Test Access Port and Boundary-Scan Architecture for test access ports that is used for testing printed circuit boards using boundary scan. While designed for printed circuit boards, JTAG is primarily used for the testing of sub-blocks of integrated circuits, and further, is also used as a mechanism for debugging embedded systems, thus providing a back door entry into a system.

Upon determining that an excessive number of relative memory error events have occurred within a computing system, the present invention provides for the generation and delivery of a notification containing the details of systemic computing errors to relevant system administrators and/or hardware service support. This capability allows for remedial actions to be put in place to ensure that a relevant compute node can be scheduled for appropriate action (e.g., swap out during the next preventative maintenance period or in more extreme cases, scheduled for immediate action).

Within aspects of the present invention excessive numbers of memory error are defined as: a percent difference relative to the other compute nodes in the system, as an absolute value that should not be exceeded, or both. Structurally, Blue Gene/L computing systems comprise compute nodes wherein JTAG interfaces are linked to each compute node. Due to this structural configuration, the Blue Gene/L computing system is unique in its ability to monitor system memory errors via a JTAG network without having an impact on the performance of running applications.

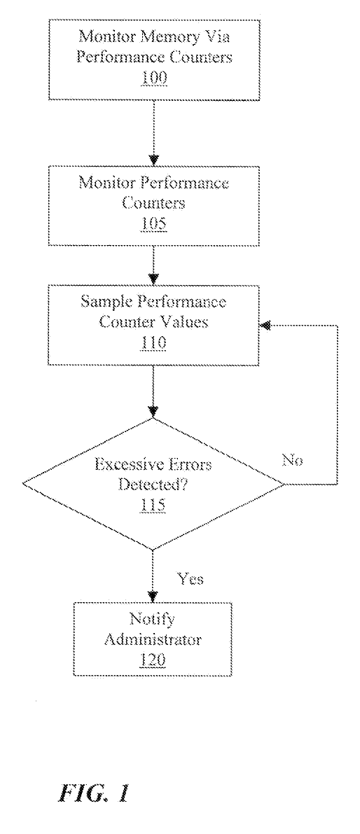

Turning now to the drawings in greater detail, it will be seen that in FIG. 1 there is a flow diagram detailing aspects of a memory error monitor that can be implemented within aspects of the present invention. The performance counters monitor the memory performance of the Blue Gene/L computing system at step 100. At step 105, an external process on the service compute node of the Blue Gene/L system monitors the relevant memory error performance counters on all of the compute nodes of the Blue Gene/L system by way of a JTAG network interface.

At step 110, the external process periodically samples the values acquired by the performance counters across all of the compute nodes in the system, and then compares the performance counter values to a predetermined acceptable memory error tolerance value. A system administrator can determine the time periods for the acquisition of performance counter values, and configure the external application to acquire memory error tolerance values within the predetermined time periods. In the event that an acceptable memory error tolerance value is not known, the relative performance values between respective compute nodes can be compared; in this instance each compute node will have percent difference in its performance value relative to the performance values of the other compute nodes.

A determination is made at step 115 whether a given absolute or relative percentage difference performance value threshold has been exceeded. In the event that it is determined that a given absolute, or relative percentage difference performance threshold value has been exceeded, an appropriate person(s) (e.g., system administrator or hardware service support) is notified (e.g., via email) that there is an occurrence of a possible systemic hardware anomaly, such as a bad compute node (step 120). The alert notification response can be customized for a computing site (such as notifying a system user, the refunding of CPU hour credits, etc. . . . ). In further aspects of the present invention a customized response can also be sent to an application, for example, informing the application of a checkpoint so that the work the application has completed up to a particular time period is not lost, or to activate a warm spare compute node.

In yet further aspects of the present invention, memory error counters can be visualized using standard performance visualization tools that assist in finding hardware anomalies in real-time. Additionally, general application performance counters (e.g., L1 hits or L1 misses) can also be used to detect unexpected memory error activity. Within a computing system, the production of soft errors could result in extremely different performance characteristics between compute nodes doing very similar tasks. Therefore, in the event that the counters on a compute node have atypical values, this can serve as a possible indication of faulty hardware.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be includes as a part of a computer system or sold separately.

The flow diagrams depicted herein are just examples, There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the further, may make various improvements and enhancements which fall within the scope of the claim which follow. These claims should be construed to maintain the proper protection for the invention first described.

What is claimed:

1. A method for active real-time monitoring of memory errors, the method comprising the steps of:
monitoring a plurality of compute nodes within a computing system for memory errors by at least one performance counter;
monitoring the at least one performance counter, wherein that at least one performance counter is monitored by the use of an external monitoring application, the external monitoring application being configured to monitor the at least one performance counter by the use of a JTAG network;
acquiring sample values of memory error data that have accumulated at the at least one performance counter;
determining if a predetermined amount of memory errors has occurred at the plurality of compute nodes;
notifying a computing system administrator in the event that the predetermined amount of memory errors has occurred.

2. The method of claim 1, wherein each compute node of the computing system is configured to comprise a JTAG interface.

3. The method of claim 2, wherein the step of acquiring a value sample of memory error data that has accumulated at the at least one performance counter, further comprises the step of acquiring the memory error data sample value at predetermined time intervals.

4. The method of claim 3, wherein the step of determining if a predetermined amount of memory errors has occurred at the plurality of compute nodes comprises the step of comparing the acquired sample values of memory error data to a predetermined memory error tolerance value.

5. The method of claim 4, wherein the step of notifying a computing system administrator in the event that the predetermined amount of memory errors has occurred comprises the step of notifying the computing system administrator in the event that the acquired sample values of memory error data have been determined to be greater than the predetermined memory error tolerance value.

6. The method of claim 3, wherein the step of determining if a predetermined amount of errors has occurred at the plurality of compute nodes comprises the step of comparing the relative values between the acquired sample values of memory error data.

7. The method of claim 6, wherein the step of determining if a predetermined amount of errors has occurred at the plurality of compute nodes comprises the step of determining if the relative values between the acquired sample values of memory error data exceed a relative value threshold percentage difference.

8. The method of claim 2, wherein the computing system administrator if notified by the use of an email message, wherein the email message contains details of the computing system's accumulated memory error abnormalities.

9. The method of claim 2, wherein the at least one performance counter monitors the operations on CRC and SRAM memory for memory errors.

10. A computer program product that includes a computer readable medium useable by a processor, the medium having stored thereon a sequence of instructions which, when executed by the processor, causes the processor to monitor computing system memory errors in real-time, wherein the computer program product executives the steps of:
monitoring at least one performance counter by the use of a JTAG network, wherein the at least one performance counter is configured to monitor the operations on CRC and SRAM memory of a plurality of compute nodes within a computing system for memory errors;
acquiring sample values of memory error data that have accumulated at the at least one performance counter;
determining if a predetermined amount of memory errors has occurred at the plurality of compute nodes;
notifying a computing system administrator in the event that the predetermined amount of memory errors has occurred.

11. The computer program product of claim 10, wherein each compute node of the computing system is configured to comprise a JTAG interface.

12. The computer program product of claim 11, wherein the step of acquiring a value sample of memory error data that has accumulated at the at least one performance counter, further comprises the step of acquiring the memory error data sample value at predetermined time intervals.

13. The computer program product of claim 12, wherein the step of determining if a predetermined amount of memory errors has occurred at the plurality of compute nodes comprises the step of comparing the acquired sample values of memory error data to a predetermined memory error tolerance value.

14. The computer program product of claim 13, wherein the step of notifying a computing system administrator in the event that the predetermined amount of memory errors has occurred comprises the step of notifying the computing system administrator in the event that the acquired sample values of memory error data have been determined to be greater than the predetermined memory error tolerance value.

15. The computer program product of claim 12, wherein the step of determining if a predetermined amount of errors has occurred at the plurality of compute nodes comprises the step of comparing the relative values between the acquired sample values of memory error data.

16. The computer program product of claim 15, wherein the step of determining if a predetermined amount of errors has occurred at the plurality of compute nodes comprises the step of determining if the relative values between the acquired sample values of memory error data exceed a relative value threshold percentage difference.

17. The computer program product of claim 10, wherein the computing system administrator is notified by the use of an email message, wherein the email message contains details of the computing system's accumulated error abnormalities.
